(19) United States
(12) Patent Application Publication
(10) Pub. No.: US 2015/0328712 A1
(43) Pub. Date: Nov. 19, 2015

(54) COILED TUBING LAP WELDS BY MAGNETIC PULSE WELDING

(71) Applicant: CONOCOPHILLIPS COMPANY, Houston, TX (US)

(72) Inventor: Scott A. GRUBB, Houston, TX (US)

(21) Appl. No.: 14/715,889

(22) Filed: May 19, 2015

Related U.S. Application Data
(60) Provisional application No. 62/000,363, filed on May 19, 2014.

(51) Int. Cl. B23K 13/02; B23K 35/00; B23K 20/06

(52) U.S. Cl. CPC B23K 13/025; B23K 20/06; B23K 35/00

(57) ABSTRACT

A method for joining coiled tubing is described. Coiled tubing joints using a magnetic pulse welder are described that retain the strength of the original tubing. This type of joint is useful for joining multiple coiled tubing sections or for removing and repairing damaged coiled tubing. Because the joint is as strong as the original tubing, these types of joints may be used when placing tubing in the well.

### CROSS-REFERENCE TO RELATED APPLICATIONS

This application is a non-provisional application which claims benefit under 35 USC §119(e) to U.S. Provisional Application Ser. No. 62/000,363 filed May 19, 2014, entitled “COILED TUBING LAP WELDS BY MAGNETIC PULSE WELDING,” which is incorporated herein in its entirety.

### STATEMENT REGARDING FEDERALLY SPONSORED RESEARCH

None.

### FIELD OF THE INVENTION

The present invention relates generally to joining tubing for the production of hydrocarbons from a subterranean reservoir. More particularly, but not by way of limitation, embodiments of the present invention include lap welding two separate pieces of coiled tubing using magnetic pulse welding.

### BACKGROUND OF THE INVENTION

Coiled tubing is a means of conveyance of fluid in an oilfield, and its value is attributed to the coiled tubing being continuous, rugged, and suitably stiff. Coiled Tubing (CT) has been defined as any continuously-milled tubular product manufactured in lengths that require spooling onto a take-up reel, during the primary milling or manufacturing process. The tube is nominally straightened prior to being inserted into the wellbore and is recoiled for spooling back onto the reel.

CT may be used in oil, gas, water, and disposal wells that extend deep beneath the surface. As the measured depth of a well increases so does the difficulty level of successfully delivering CT through its full length. However, as CT is a continuous spool of rugged tubing its deployment into a well offers a considerable time savings as compared to jointed pipe alternatives. Another benefit of CT over jointed pipe alternatives is that when using CT a continuous flow of fluid can be pumped through the tubing, whereas this is not possible with jointed pipe deployments. The need for a continuous length of CT has created an industry that manufactures it. However, some issues have arisen with the use of CT.

For example, a CT manufacturer purchases steel strip and welds the ends of each strip together in order to have a length of strip long enough to manufacture the continuous roll of CT required by the purchaser. This strip end weld is performed as a bias weld also known as a scarf joint before the CT is rolled into a tube. The bias weld is done at a roughly 45 degree angle to the length of a steel strip and may be heat treated, ground flush on both sides, and thoroughly inspected prior to its transformation into CT. Once several strips have been bias welded together to form the desired length of tubing the flat strips are rolled into a tubular geometry where the strips outer edges are seam welded together producing the continuous length of tubing. After heat treatment, as part of the continuous manufacturing process, the tubing is coiled onto a spool. A bias weld offers greater fatigue performance over alternatives. Fatigue performance is desirable as CT is yielded many times during deployment into wells and lesser joining technologies would fail far earlier. The bias weld minimizes the potential of fatigue and weld related failures from occurring during the coiling and uncoiling process. Even using a bias weld, CT will often fail at these bias welds. Each time the coil tubing is uncoiled and recoiled, the tubing experiences plastic deformation, and the bias weld is the weakest point of the tubing.

Another issue that has arisen with CT involves the length of tubing that may be placed on a single reel. It is apparent that the largest diameter reel may not hold the length of tubing that may be needed for use in deeper wells. The diameter of the reel is limited by the largest diameter that may be transported on public roads as well as the equipment that transports the reels to sometimes very remote locations. These coils may be as large as 25 feet in diameter.

Understanding CT fatigue and plasticity behavior are critical to CT's successful implementation in the field. Analytical models now monitor CT life for every segment of tubing along its entire length, based on its individual pressure/cycling history. Jobs can be analyzed using software, before the hardware is actually placed over a well, virtually eliminating fatigue failures. Not surprisingly, the fatigue endurance of CT can be affected by the presence of defects, which occur regularly in harsh oilfield environments. Zheng & Smith, WO2012174057, establish a model of fatigue life for CT which addresses repeated bend cycles during operation.

However, when the CT is damaged, it is difficult to repair. Repair of the CT may mean that the entire coil of tubing is wound onto a large spool or reel and taken back to a repair facility. The damaged section of CT is removed, and then the ends of the CT are welded together. Unfortunately, joints on the round, or potentially oval, CT are more complicated to make and typically less reliable than when originally manufactured.

Kuchuk-Yatsenko, U.S. Pat. No. 6,211,489, uses magnetically impelled arc butt welding, by controlling the displacement of the parts being welded during heating and monitoring the size of the gap between their edges, thus providing the constant value of welding voltage during welding. Van den Steen and Kriesels, US20130239643, provide radially expanding a tubular element by bending the tubular element radially outward and in axially reverse direction so as to form an expanded tubular section extending around an unexpanded tubular section, wherein bending occurs in a bending zone, increasing the length of the expanded tubular section by inducing the bending zone to move in axial direction relative to the unexpanded tubular section; and heating the bending zone. Fleck, et al., WO2013173381, use friction stir joining using a combination of a disposable or reusable mandrel to react the loads from friction stir joining, and a system for manipulating the CT so that friction stir joining may be performed while the CT is on a reel and/or at a field site. Hassel, et al., US20130092670 and US20130092665, teach methods for making a welded connection between tubulars using magnetically impelled arc butt (MIAB) welding.

During friction stir joining, the area to be joined and the tool are moved relative to each other such that the tool traverses a desired length of the weld joint at a tool/workpiece interface. The rotating friction stir welding tool provides a continual hot working action plasticizing metal within a narrow zone. MIAB also heats facing ends of a pair of wellbore tubulars. After the facing ends are heated and/or melted, a force application device compressively engages the facing ends to form a welded joint. Unfortunately the repair strength does not typically meet requirements to continue use of the CT and once removed from the wellbore, the CT cannot be reused if the tubing has been repaired. Even the best butt-welded joint may not last for more than half of the coiled tubes' rated fatigue life. This is because basic tensile and hoop stress properties may be compromised. One reason for this is that when making the weld, the welder does not have access to the inside of the tubing to control the internal profile of the weld.

Reels of CT may need to be joined together in the field in order to have the length that may be needed for deeper wells. Welding different reels of CT together is not desirable at the manufacturer location or the field location since the weld may not be biased, resulting in a substantial loss of that joints fatigue life and tensile strength. While it is possible to join CT using mechanical connectors, they produce a joint that may only be capable of being coiled a few times and must be capable of passing through the injector and stuffing box similarly to the CT.

The problems with CT therefore include difficulty in repairing existing tubing that is already coiled, and difficulty in joining multiple coils together. Ongoing research is helping to quantify the influence of defects, and to develop techniques for making quick and cost-effective repairs in the field.

Better welding techniques are required. Under normal operations, butt welds are used with CT deployed in low pressure wells or in emergencies to remove existing pipe. For high pressure wells an alternative to butt welding is required that will not damage or decrease the strength of the pipe at the weld location. What is required is a welding technique that can maintain CT strength allowing extension, repair and/or reuse of CT in the field.

### BRIEF SUMMARY OF THE DISCLOSURE

The invention more particularly includes using Electromagnetic Pulse Technology (EMPT) to provide a high strength CT joint. Because the joint strength is equal to the strength of the work piece, there will be little or no loss of CT integrity when using EMPT to weld CT. In addition EMPT welding can produce helium-tight connections of different metallic materials without creating a heat affected zone. Stainless steels, which are often difficult to weld by fusion welding, can be welded by EMPT and even dissimilar welds between steel and aluminum, steel and copper, as well as copper and aluminum are feasible.

In one embodiment, a process for joining CT is described where the end of one CT is reamed on the inside to create a female end and the end of another CT is reamed on the outside to create a complementary male end. The male CT is placed in the female CT to make a CT lap joint and an electromagnetic compression coil is placed around the CT lap joint. Then the female CT is compressed onto the male CT to form a tight weld.

In another embodiment, a process for joining CT is described where an expansion coil is placed in a CT end and the CT end is expanded to create an expanded CT end. The expanded CT end is placed over a CT to make a CT joint. An electromagnetic compression coil is placed around the CT joint and the expanded CT is compressed onto the CT to form a tight weld.

In another embodiment, a process for joining CT is described where a conductive sleeve is placed over one CT end. A second CT end is placed in the conductive sleeve to make a CT joint. An electromagnetic compression coil is placed around the CT joint and the conductive sleeve is compressed onto the CT ends to form a tight weld.

Additionally, a mandrel may be placed in any of the above CT joints in order to maintain tubing shape and to provide a support for the joint during welding. This mandrel may be removable or permanent, where removal may be achieved mechanically, hydraulically, or by dissolution. A permanent mandrel would allow through circulation of fluids and preferably be able to pass items required to actuate down hole equipment. The CT ends may be beveled or shaped to increase surface area and provide a complementary connection. The above process may be used on a variety of CT sizes. The CT may have an outside diameter ranging from 0.5 to 4.5 inches. Specifically 0.75, 1.0, 1.25, 1.5, 1.75, 2.0, 2.375, 2.625, 2.875, 3.5, and 4.5 inches or approximately 1.5, 2, 2.5, 3, 4, 5, 6, 7, 8, 9, 10, 11, 12, 13, 14, or 15 centimeters are typical outer diameters. Larger size outer diameters are possible and may be seen more as coiled tubing technology continues to develop. The CT may have a wall thickness of approximately 0.08, 0.087, 0.095, 0.102, 0.109, 0.116, 0.125, 0.134, 0.145, 0.156, 0.175, 0.19, 0.204, 0.224, 0.25, 0.276, 0.3, or 0.337 inches or approximately 12.7, 13, 15, 20, 25, 30, 35, 40, 45, 50, 55, 60, 65, 70, 75, 80, 85, 90, 95, 100, 105, 110, 115, 120 125, or 130 millimeters. The thicker tubing sizes may be reamed to create a thinner female fitting appropriate for MPW.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts expansion of a CT end.

FIG. 2 depicts milling of complementary female and male CT ends.

FIG. 3 depicts a variety of milling angles for complementary female and male CT ends.

FIG. 4 depicts MPW of an expanded CT end and a complementary CT end.

FIG. 5 depicts MPW of complementary milled CT ends.

FIG. 6 depicts MPW of two CT ends with a joining sleeve.

FIG. 7 depicts MPW with a removable mandrel.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

As used herein, the terms “tubular”, “coiled tubing”, “tube”, “tubing”, “drillpipe,” “pipe” and other like terms can be used interchangeably.

Casing as used herein refers to a larger diameter pipe relative to a production tubular. Casing provides a smooth internal bore and protects the production tubing from surrounding formation. Casing may be cemented in place. It may also be used to isolate different zones, protect fresh water aquifers, seal off high pressure zones, prevent fluid loss, and/or prevent contamination.

As used herein coiled tubing (CT) refers to a continuous length tube which is spooled on a large reel.

CT outer diameters range from 0.75 inches (<2 cm) to as great as 5 inches (˜13 cm). It is fabricated in a variety of material grades, characterized by minimum monotonic yield strengths of 60, 70, 80, 90, 100, 110 and 120 ksi. One material used for coiled tubing is a high-strength low-alloy (HSLA) steel. CT wall thickness varies from approximately 0.05 inches (˜12.7 mm) up to 0.5 inches (1.27 cm) wall thickness. Although these sizes do not limit the techniques described herein as larger and thicker CT continues to be developed along with welding and material handling improvements.

CT material is essentially carbon steel, modified for grain size refinement. The grain size of typical coiled tubing material is extremely fine; so fine it lies outside the range recognized by ASTM's standard series of photomicrographs. The finest grainsize recognized has an ASTM number of “10” while CT extrapolates to a grain size number of about 12. CT may also be manufactured out of stainless steel, Inconel, ASTM A269; ASTM A249, ASTM 554, Corrosion Resistant Alloy (CRA), Low Alloy Steel, high-strength low-alloy (HSLA) steel, and the like.

The API Specification for casing and tubing, 5CT (2001 edition), lists ten different grades with 19 variations. H-40 is the lowest strength grade and Q-125 is the highest. The grades can be electric resistance welded (ERW) or seamless (S). They can be supplied in the as-rolled condition or heat treated. Heat treatment may consist of normalizing and tempering (N&T), quench and tempering (Q&T), or normalized only (N). API 5CT is also issued as ISO 11960.

The terms CT and/or casing may be used in combination with “joint”, “segment”, “section”, “string” and other like terms referencing a length of tubular.

Magnetic Pulse Welding (MPW) uses Electromagnetic Pulse Technology (EMPT) to join electrically conductive materials. A very high AC current (the “primary current”) is passed through a conductive coil (the “inductor”) near an electrically conductive material. An intense magnetic field is locally produced that generates a secondary eddy current, a Lorentz force, which accelerates the conductive material at a very high velocity. A stationary material (base material) is positioned in the trajectory of the conductive material thus producing an impact which causes a solid state weld.

Tubular structures can be compressed or expanded by electromagnetic pulse forming. In most cases mandrels or dies are used to ensure geometric tolerances in both compression and expansion, but die-less forming is also possible. Occasionally split mandrels or dies are used to separate these and the work piece after forming.

TABLE 1
Abbreviations

| | |
|---|---|
| CT | Coiled Tubing |
| MPW | Magnetic Pulse Welding |
| AC | Alternating Current |
| EMPT | Electromagnetic Pulse Technology |

The following examples of certain embodiments of the invention are given. Each example is provided by way of explanation of the invention, one of many embodiments of the invention, and the following examples should not be read to limit, or define, the scope of the invention.

### Example 1

### EMPT Tubing Expansion

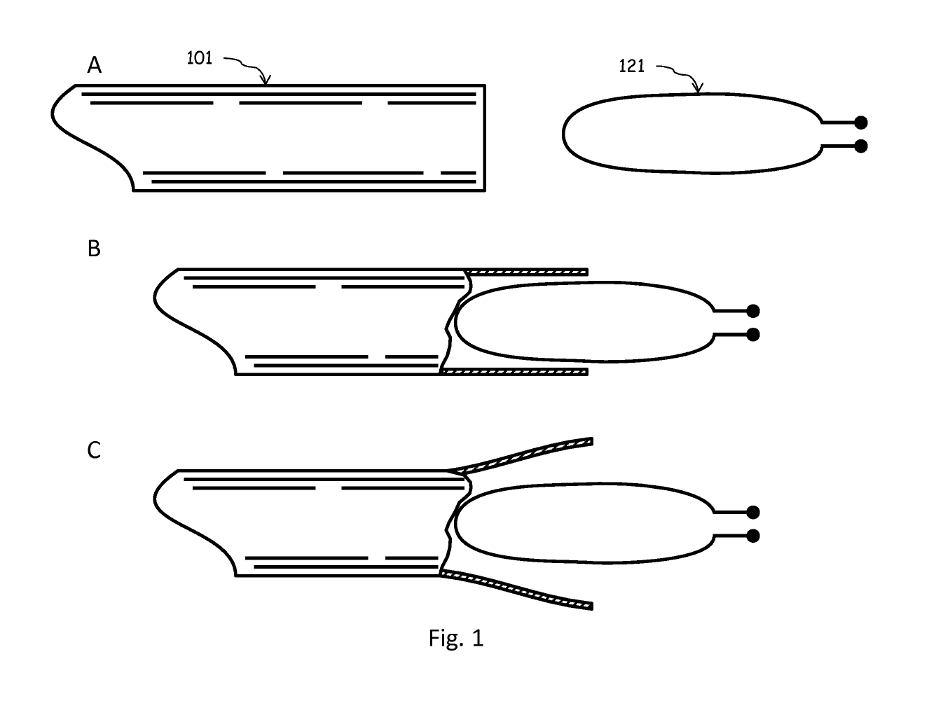

Coiled tubing is expanded to where the inside diameter of the expanded tubing is greater than the outside diameter of the complementary tubing end. In one embodiment a damaged section of tubing is identified and removed. In another embodiment, one end of a CT is to be joined with an existing CT. The CT end is inspected, if the tubing is too thin, misshapen, cracked or damaged, the piece may be cut back. The end piece may be cut flat and or cleaned of burrs, dirt, and anomalies. Once the end is ready to be expanded an expansion coil 121 is inserted into the coiled tubing 101. A pulsed energy source is transmitted through the expansion coil 121 causing the coiled tubing 101 to expand as shown in FIG. 1. Optionally a mandrel, casing, or die may be placed around the CT to obtain a specific geometric shape or diameter of expansion. If the CT has insufficient conductivity, it may cause ohmic losses and heating. To overcome this a driver, i.e. thin walled copper, aluminum, or other conductive metal tubing or ring, may be used to push the CT outward. The expanded CT end may have multiple uses.

### Example 2

### Conventional Tubing Reaming

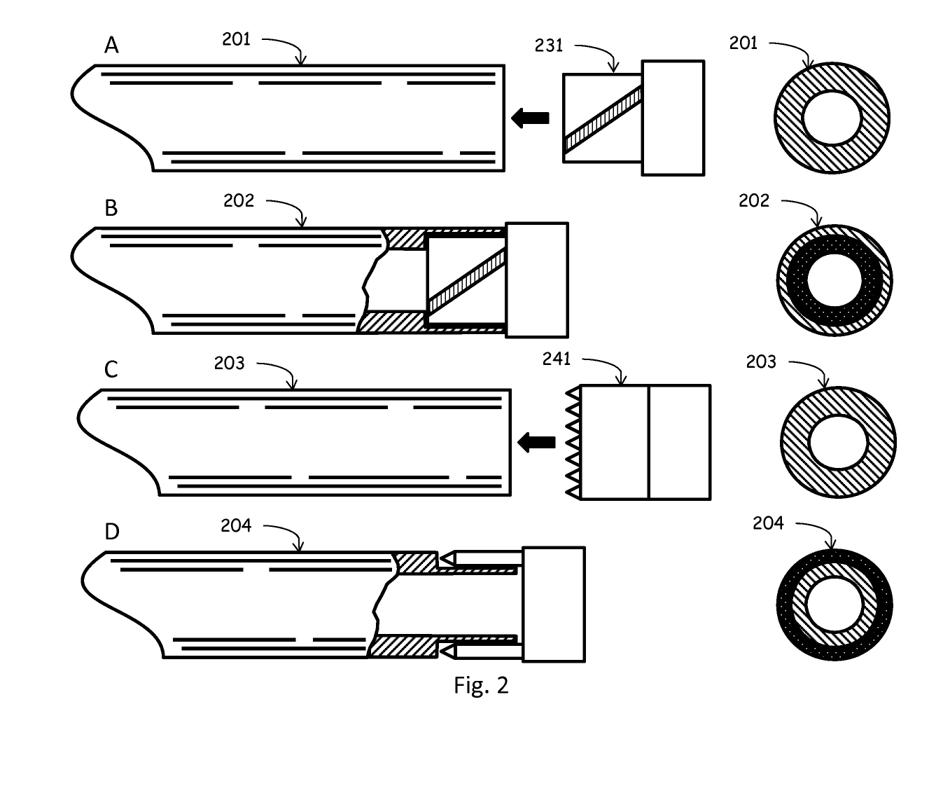

CT is reamed to create a male and female end as shown in FIG. 2. One simple method for reaming involves using a press to insert a reaming bit internally 231 or externally 241. The reaming bit has an exact diameter internally and externally ensuring that the reamed female end will fit tightly over the reamed male end. There may be additional clamps, vices and guides in place to ensure the reaming is centered and that the two ends are complementary to very high tolerances. After reamed, the female end 202 has an outside wall and the internal surface is cut away. The male end 204 has an inside wall and the outside surface is cut away. The cut away section is depicted as black area in the end view.

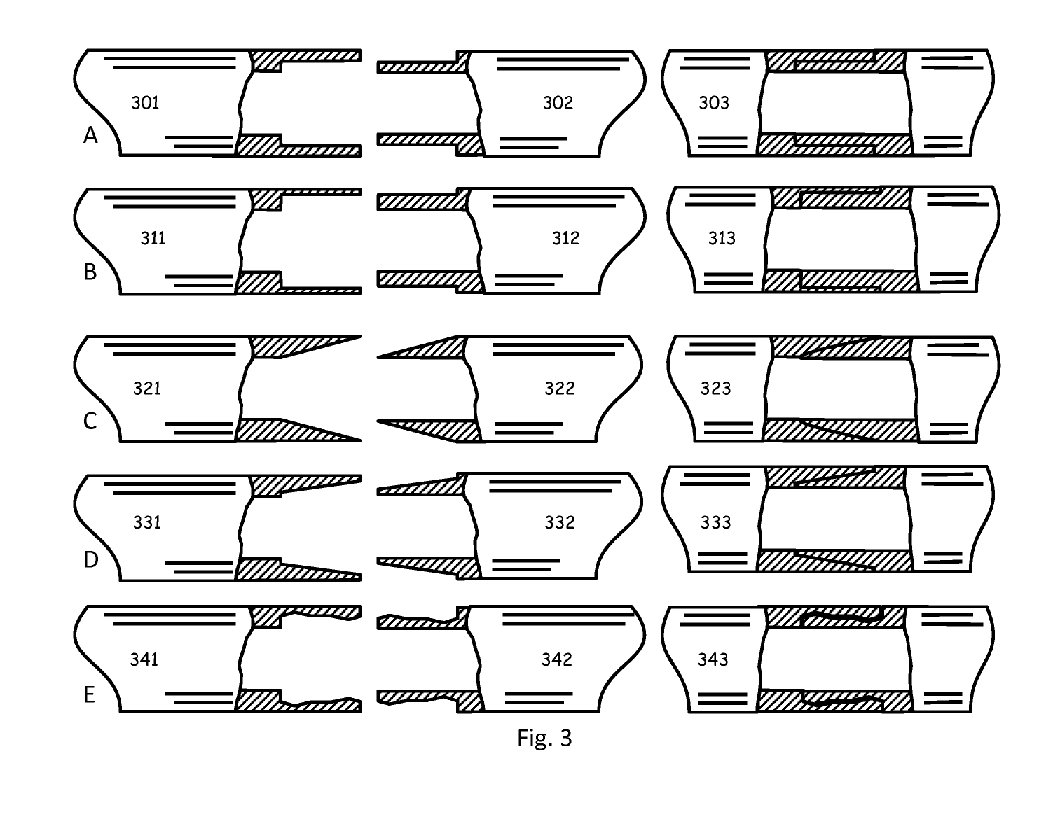

CT may be reamed to create overlapping ends of various geometries as shown in FIG. 3. This may be done with shaped bits or with a rotating die that is placed over the end of the tubing. FIG. 3A depicts complementary female 301 and male 302 ends that are nearly the same wall thickness. FIG. 3B depicts complementary female 311 and male 312 ends where one end has a thinner wall thickness and the other is thicker. In one embodiment a thinner female wall provides a malleable surface for MPW. Beveling the ends as depicted in FIG. 3C with the beveled female 321 and beveled male 322 ends ensures that there is a perpendicular component to the EMP along the entire length of the joint. A combination of techniques may be used to ensure proper seating and a large enough surface to weld. In FIG. 3D a beveled surface with a shoulder is used to ensure proper seating and large welding surface. FIG. 3E depicts an interlocking surface that may be pressed together and snaps, or locks into place.

### Example 3

### MPW with Expanded Tubing

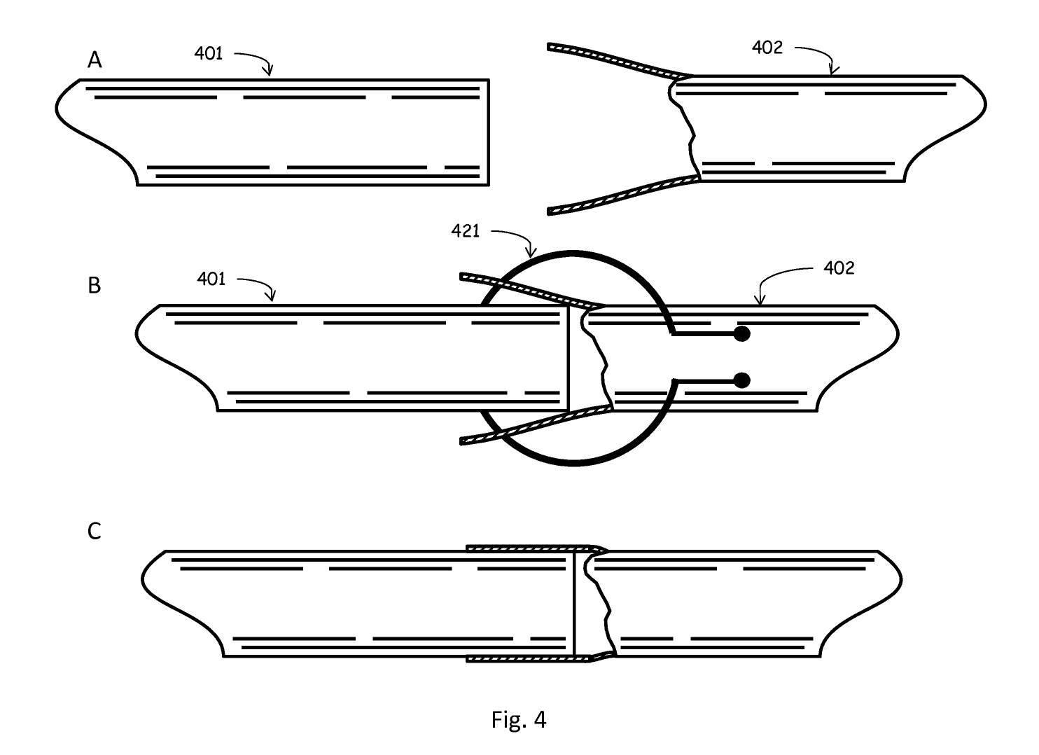

Expanded tubing may be joined to standard CT to create a continuous piece of CT with no disruption to the internal diameter of the tubing as shown in FIG. 4. A cleaned CT end 401 is placed in an expanded tubing end 402. The MPW compression coil 421 is used to compress the expanded tubing onto the CT end creating a continuous piece of CT. Because the MPW retains the strength of the bonded materials, this weld will not decrease the tubing quality and may be used on tubing as it is being placed downhole.

### Example 4

### MPW with Reamed Tubing

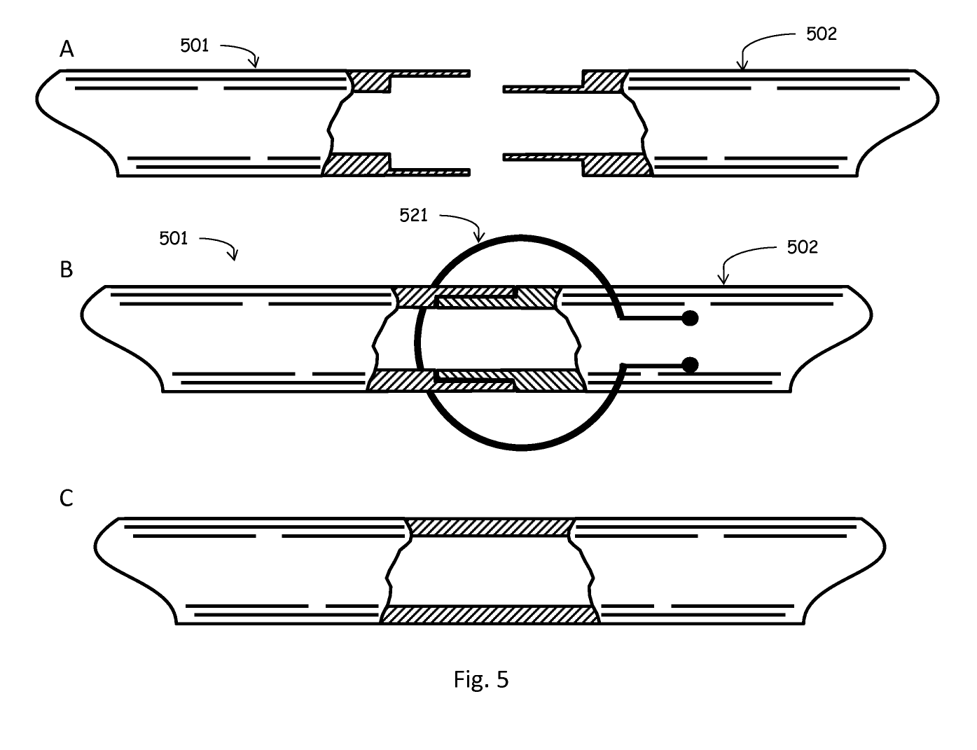

Complementary male and female CT tubing ends may be joined by MPW as shown in FIG. 5. The reamed female 501 and male 502 CT ends are placed together and a compression coil is run over the joint. This type of joint does not change the internal or external diameter of the coiled tubing. The overlapping surface provides a tight and durable seal that is nearly as strong as the original tubing. There is little or no loss of tubing quality with this type of weld. Various ends may be used to ensure a tight fit and a large welded surface as shown in FIG. 3.

### Example 5

### MPW with a Sleeve

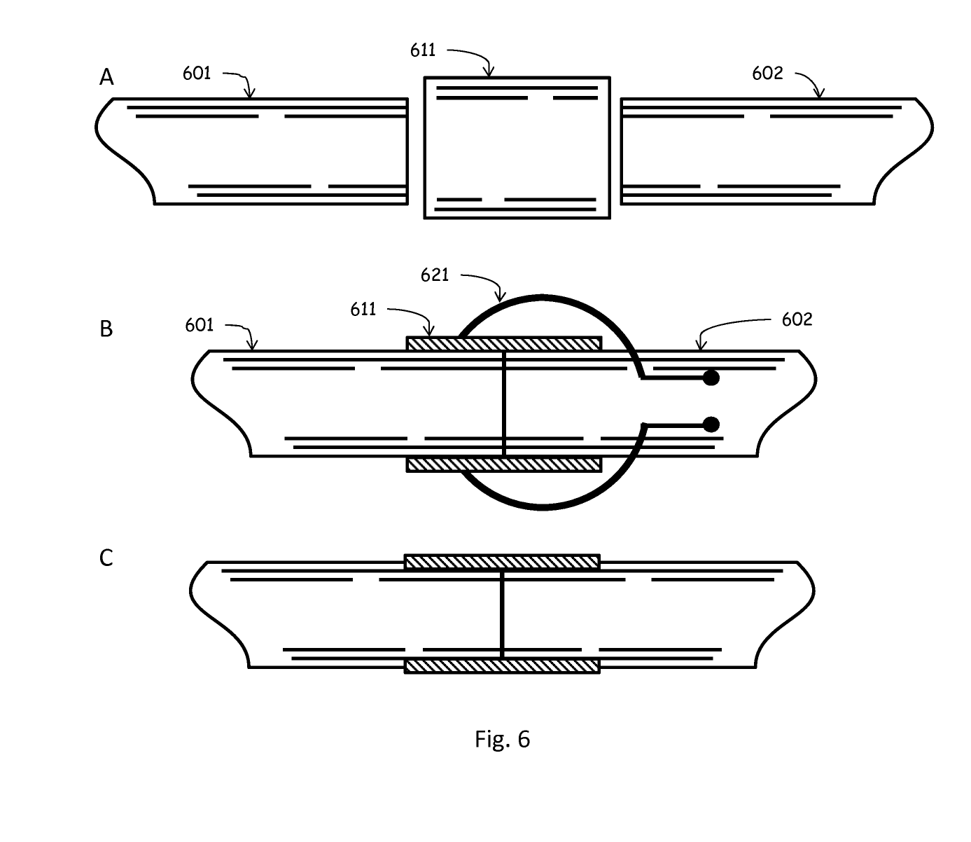

A sleeve may be used to join two prepared CT ends as shown in FIG. 6. The sleeve 611 may be any material that is conductive because MPW can joint two different metal types. Additionally, because the sleeve is short, it may be made out of more expensive, durable, flexible, and/or chemically resistant materials than the coiled tubing itself. In one embodiment the sleeve is a bimetal sleeve with high tensile steel surrounded by aluminum, the aluminum coating will drive the high tensile steel into the coiled tubing providing a tight seal that is stronger than the original CT. Care must be taken to ensure the sleeve material is flexible and does not crack or strain when the tubing is put out or taken up.

### Example 6

### MPW with Mandrel

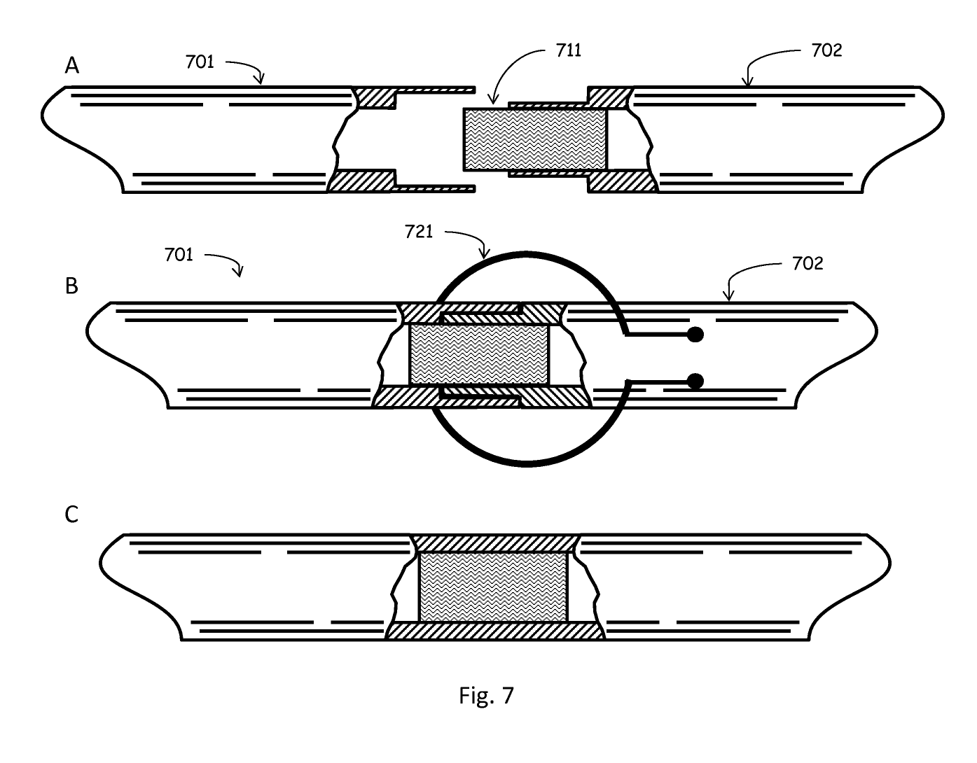

Each of the methods above may be performed with a mandrel to ensure the tubing inside diameter is not compromised during welding. A mandrel is placed within the weld when the two pieces are brought together as shown in FIG. 7. The mandrel may be a dissolvable or pumpable mandrel. A dissolvable mandrel may be solid, tubular or may have multiple flow-through channels to facilitate dissolution when the weld is completed. In one embodiment a dissolvable metal mandrel is used to support the weld area from the inside to prevent distortion. Once the weld is complete an acid or solvent may be used to dissolve the mandrel. A pump removable mandrel may also be used to support the weld and prevent distortion. The pump removable mandrel is forced out of the tubing once the weld is complete. The mandrel may be solid or multiple pieces that separate when subjected to differential pressure. The mandrel may also be a solid that is soluble in solution such as a plastic polymer that would be soluble in a solvent such as a thinner or other organic solvent. The mandrel may also be a solid that is soluble in an aqueous solution such a compressed cellulosic material.

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. U.S. Pat. No. 6,211,489, GB2333484, “Method of Magnetically Impelled Arc Butt Welding,” EO Paton Electric Welding (2001).
2. US20130239643, W0201272720, “Method and System for Radially Expanding a Tubular Element,” Van Den Steen and Kriesels (2013).
3. WO2013173381, “Apparatus to Join Tubulars Using Friction Stir Joining,” Fleck, et al. (2013).
4. WO2012174057, WO2012103541, “Coiled Tubing Useful Life Monitor and Technique,” Schlumberger (2012).
5. US20130092670, W0201355598, “Enhanced Magnetically Impelled Arc Butt Wielding (MIAB) Technology,” Baker Hughes Inc. (2013)
6. US20130092665, W0201355600, “Arc Guiding, Gripping and Sealing Device for a Magnetically Impelled Butt Welding Rig,” Baker Hughes, Inc. (2013)
7. Schäfer, et al., “The Electromagnetic Pulse Technology (EMPT): Forming, Welding, Crimping and Cutting” PSTProducts GmbH, Alzenau Germany (2009)

1) A process for joining coiled tubing comprising:
reaming a female end on a coiled tubing;
reaming a complementary male end on a coiled tubing;
placing the male coiled tubing in the female coiled tubing to make a coiled tubing joint;
placing an electromagnetic compression coil around the coiled tubing joint; and
compressing the female coiled tubing onto the male coiled tubing to form a tight weld.

2) The method of claim 1, wherein a removable mandrel is placed in the coiled tubing joint.

3) The method of claim 1, wherein a permanent mandrel is placed in the coiled tubing joint said permanent mandrel having a cavity to allow through circulation of fluids or items.

4) The method of claim 1, wherein one or more coiled tubing ends are beveled.

5) The method of claim 1, wherein said coiled tubing has an outside diameter of 1.5, 2, 2.5, 3, 4, 5, 6, 7, 8, 9, 10, 11, 12, 13, 14, or 15 centimeters or approximately 0.75, 1, 1.25, 1.5, 1.75, 2, 2.375, 2.625, 2.875, 3, 3.5, 4, 4.5 or 5 inches.

6) The method of claim 1, wherein said coiled tubing has a wall thickness of approximately 12.7, 13, 15, 20, 25, 30, 35, 40, 45, 50, 55, 60, 65, 70, 75, 80, 85, 90, 95, 100, 105, 110, 115, 120 125, or 130 millimeters or approximately 0.05, 0.08, 0.087, 0.095, 0.10, 0.102, 0.109, 0.116, 0.125, 0.134, 0.145, 0.15, 0.156, 0.175, 0.19, 0.20, 0.204, 0.224, 0.25, 0.276, 0.3, 0.337, 0.35, 0.40, 0.45, 0.50, 0.55, 0.60, or 0.65 inches thick.

7) A process for joining coiled tubing comprising:
placing an expansion coil in a coiled tubing end;
expanding the coiled tubing end to create an expanded coiled tubing end;
placing the expanded coiled tubing end over a coiled tubing to make a coiled tubing joint;
placing an electromagnetic compression coil around the coiled tubing joint; and
compressing the expanded coiled tubing onto the coiled tubing to form a tight weld.

8) The method of claim 7, wherein a removable mandrel is placed in the coiled tubing joint.

9) The method of claim 7, wherein a permanent mandrel is placed in the coiled tubing joint said permanent mandrel having a cavity to allow through circulation of fluids or items.

10) The method of claim 7, wherein one or more coiled tubing ends are beveled.

11) The method of claim 7, wherein said coiled tubing has an outside diameter of 1.5, 2, 2.5, 3, 4, 5, 6, 7, 8, 9, 10, 11, 12, 13, 14, or 15 centimeters or approximately 0.75, 1, 1.25, 1.5, 1.75, 2, 2.375, 2.625, 2.875, 3, 3.5, 4, 4.5 or 5 inches.

12) The method of claim 7, wherein said coiled tubing has a wall thickness of approximately 12.7, 13, 15, 20, 25, 30, 35, 40, 45, 50, 55, 60, 65, 70, 75, 80, 85, 90, 95, 100, 105, 110, 115, 120 125, or 130 millimeters or approximately 0.05, 0.08, 0.087, 0.095, 0.10, 0.102, 0.109, 0.116, 0.125, 0.134, 0.145, 0.15, 0.156, 0.175, 0.19, 0.20, 0.204, 0.224, 0.25, 0.276, 0.3, 0.337, 0.35, 0.40, 0.45, 0.50, 0.55, 0.60, or 0.65 inches thick.

13) A process for joining coiled tubing comprising:
placing a conductive sleeve over a coiled tubing end;
placing a second coiled tubing end in the conductive sleeve to make a coiled tubing joint;
placing an electromagnetic compression coil around the coiled tubing joint; and
compressing the conductive sleeve onto the coiled tubing ends to form a tight weld.

14) The method of claim 13, wherein a removable mandrel is placed in the coiled tubing joint.

15) The method of claim 13, wherein a permanent mandrel is placed in the coiled tubing joint said permanent mandrel having a cavity to allow through circulation of fluids or items.

16) The method of claim 13, wherein one or more coiled tubing ends are beveled.

17) The method of claim 13, wherein said coiled tubing has an outside diameter of 1.5, 2, 2.5, 3, 4, 5, 6, 7, 8, 9, 10, 11, 12, 13, 14, or 15 centimeters or approximately 0.75, 1, 1.25, 1.5, 1.75, 2, 2.375, 2.625, 2.875, 3, 3.5, 4, 4.5 or 5 inches.

18) The method of claim 13, wherein said coiled tubing has a wall thickness of approximately 12.7, 13, 15, 20, 25, 30, 35, 40, 45, 50, 55, 60, 65, 70, 75, 80, 85, 90, 95, 100, 105, 110, 115, 120 125, or 130 millimeters or approximately 0.05, 0.08, 0.087, 0.095, 0.10, 0.102, 0.109, 0.116, 0.125, 0.134, 0.145, 0.15, 0.156, 0.175, 0.19, 0.20, 0.204, 0.224, 0.25, 0.276, 0.3, 0.337, 0.35, 0.40, 0.45, 0.50, 0.55, 0.60, or 0.65 inches thick.
